(19) United States
(12) Patent Application Publication
(10) Pub. No.: US 2025/0376931 A1
(43) Pub. Date: Dec. 11, 2025

(54) GAS TURBINE ENGINE WITH VARIABLE FAN EXIT GUIDE VANES

(71) Applicant: RTX Corporation, Farmington, CT (US)

(72) Inventors: Dmitriy Sidelkovskiy, Ellington, CT (US); Flavien Thomas, Suamico, WI (US); Michael Winter, New Haven, CT (US); Daniel Kupratis, Wallingford, CT (US)

(73) Assignee: RTX Corporation, Farmington, CT (US)

(21) Appl. No.: 18/734,310

(22) Filed: Jun. 5, 2024

(51) Int. Cl. F01D 17/16

(52) U.S. Cl. CPC F01D 17/162; F05D 2220/32

(57) ABSTRACT

A gas turbine engine with variable fan exit guide vanes including a fan duct supporting a circumferential pattern of variable fan exit guide vanes, the variable fan exit guide vanes being adjustable about an axis extending along a span of each of the variable fan exit guide vanes; and an actuator in operative communication with the variable fan exit guide vanes, the actuator configured to independently adjust an incidence angle of each of the variable fan exit guide vanes responsive to predetermined gas turbine operating conditions.

### BACKGROUND

The present disclosure is directed to the improved gas turbine engine with variable fan exit guide vanes.

Current gas turbine engine design, as seen in FIG. 1 through FIG. 4, includes a design with non-variable fan exit guide vanes (FEGV). The fan F is positioned within the fan duct FD proximate the engine inlet EI. The fan exit guide vanes FEGV are downstream from the fan F and located forward of the bypass duct BD.

A current FEGV pattern is created to minimize airflow back pressure adverse effect on fan blades F caused by the downstream presence of nacelle N bypass duct BD elements (FIG. 2), such as the upper and lower bifurcation BiFi, air-to-oil cooler cowl AOC, and environmental control system inlet ECS.

As seen in FIG. 3, the FEGV has a circumferential pattern CP made up of vanes V of different cambers C (FIG. 4) and trailing edge angles. But all vane types are designed with the same fixed installation angles, and with around the same leading-edge incident angles. The vanes are not adjustable after installation during engine operation. Additionally, the FEGV pattern aims to optimize the fan duct performance and acoustic characteristics of the gas turbine engine.

The FEGV pattern is defined to meet structural, performance and acoustic requirements across a wide range of operating conditions. It is therefore not optimized at any mission single condition, like cruise condition and climb condition.

### SUMMARY

In accordance with the present disclosure, there is provided a gas turbine engine with variable fan exit guide vanes comprising a fan duct supporting a circumferential pattern of variable fan exit guide vanes, the variable fan exit guide vanes being adjustable about an axis extending along a span of each of the variable fan exit guide vanes; and an actuator in operative communication with the variable fan exit guide vanes, the actuator configured to independently adjust an incidence angle of each of the variable fan exit guide vanes responsive to predetermined gas turbine operating conditions.

A further embodiment of any of the foregoing embodiments may additionally and/or alternatively include the actuator is configured to adjust an installation angle from an original predetermined value to another value for each of the variable fan exit guide vanes.

A further embodiment of any of the foregoing embodiments may additionally and/or alternatively include each of the variable fan exit guide vanes is contiguous along an entire span extending between fan duct walls supporting the variable fan exit guide vanes.

A further embodiment of any of the foregoing embodiments may additionally and/or alternatively include each of the individual variable fan exit guide vanes are configured individually adjustable during operation of the gas turbine engine operation.

A further embodiment of any of the foregoing embodiments may additionally and/or alternatively include the gas turbine engine with variable fan exit guide vanes further comprising a controller in operative communication with the actuator.

A further embodiment of any of the foregoing embodiments may additionally and/or alternatively include each of the variable fan exit guide vanes are configured adjustable throughout the entire circumferential pattern.

A further embodiment of any of the foregoing embodiments may additionally and/or alternatively include each of the variable fan exit guide vanes can be at least one of adjusted to direct an exit airflow away from a downstream object and adjusted to direct exit airflow toward a downstream object.

In accordance with the present disclosure, there is provided a gas turbine engine with variable fan exit guide vanes comprising a fan located within a fan duct; a circumferential pattern of variable fan exit guide vanes supported within the fan duct downstream from the fan, the variable fan exit guide vanes being adjustable about an axis extending along a span of each the variable fan exit guide vanes; an actuator in operative communication with the variable fan exit guide vanes, the actuator configured to independently adjust an incidence angle of each of the variable fan exit guide vanes responsive to predetermined gas turbine operating conditions; and a controller in operative communication with the actuator.

A further embodiment of any of the foregoing embodiments may additionally and/or alternatively include the actuator is configured to adjust an installation angle from an original predetermined value to another value for each of the variable fan exit guide vanes.

A further embodiment of any of the foregoing embodiments may additionally and/or alternatively include each of the variable fan exit guide vanes is contiguous along an entire span extending between fan duct walls supporting the variable fan exit guide vanes.

A further embodiment of any of the foregoing embodiments may additionally and/or alternatively include each of the individual variable fan exit guide vanes are configured individually adjustable during operation of the gas turbine engine operation.

A further embodiment of any of the foregoing embodiments may additionally and/or alternatively include each of the variable fan exit guide vanes are configured adjustable throughout the entire circumferential pattern.

A further embodiment of any of the foregoing embodiments may additionally and/or alternatively include each of the variable fan exit guide vanes can be at least one of adjusted to direct an exit airflow away from a downstream object and adjusted to direct exit airflow toward a downstream object.

In accordance with the present disclosure, there is provided a process for a gas turbine engine with variable fan exit guide vanes comprising supporting a circumferential pattern of variable fan exit guide vanes in a fan duct; configuring the variable fan exit guide vanes adjustable about an axis extending along a span of each of the variable fan exit guide vanes; and coupling an actuator in operative communication with the variable fan exit guide vanes; and configuring the actuator to independently adjust an incidence angle of each of the variable fan exit guide vanes responsive to predetermined gas turbine operating conditions.

A further embodiment of any of the foregoing embodiments may additionally and/or alternatively include the process further comprising configuring the actuator to adjust an installation angle from an original predetermined value to another value for each of the variable fan exit guide vanes.

A further embodiment of any of the foregoing embodiments may additionally and/or alternatively include the process further comprising configuring each of the variable fan exit guide vanes contiguous along an entire span extending between fan duct walls supporting the variable fan exit guide vanes.

A further embodiment of any of the foregoing embodiments may additionally and/or alternatively include the process further comprising configuring each of the individual variable fan exit guide vanes individually adjustable during operation of the gas turbine engine operation.

A further embodiment of any of the foregoing embodiments may additionally and/or alternatively include the process further comprising coupling a controller in operative communication with the actuator.

A further embodiment of any of the foregoing embodiments may additionally and/or alternatively include the process further comprising configuring each of the variable fan exit guide vanes adjustable throughout the entire circumferential pattern.

A further embodiment of any of the foregoing embodiments may additionally and/or alternatively include the process further comprising configuring each of the variable fan exit guide vanes can be at least one of adjusted to direct an exit airflow away from a downstream object and adjusted to direct exit airflow toward a downstream object.

Other details of the gas turbine engine with variable fan exit guide vanes are set forth in the following detailed description and the accompanying drawings wherein like reference numerals depict like elements.

### BRIEF DESCRIPTION OF THE DRAWINGS

FIG. 1 is a schematic representation of a prior art gas turbine engine.

FIG. 2 is a schematic representation of a prior art gas turbine engine.

FIG. 3 is a schematic representation of a prior art fan exit guide vane pattern.

FIG. 4 is a schematic representation of a prior art fan exit guide vane camber variation.

FIG. 5 is a schematic representation of an exemplary gas turbine engine with variable fan exit guide vanes.

FIG. 6 is a schematic representation of exemplary variable fan exit guide vanes.

FIG. 7 is a schematic representation of exemplary variable fan exit guide vanes.

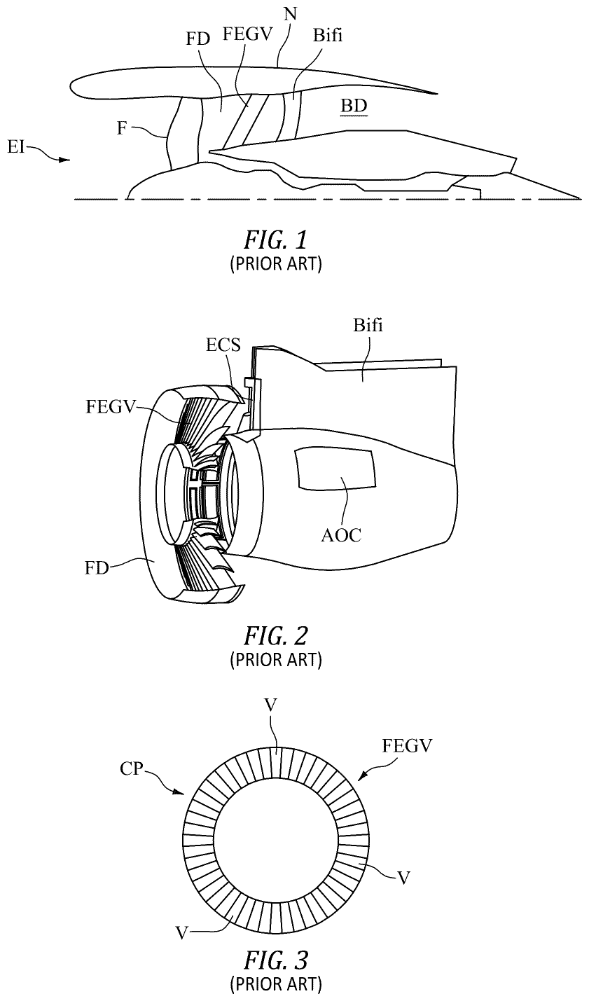

### DETAILED DESCRIPTION

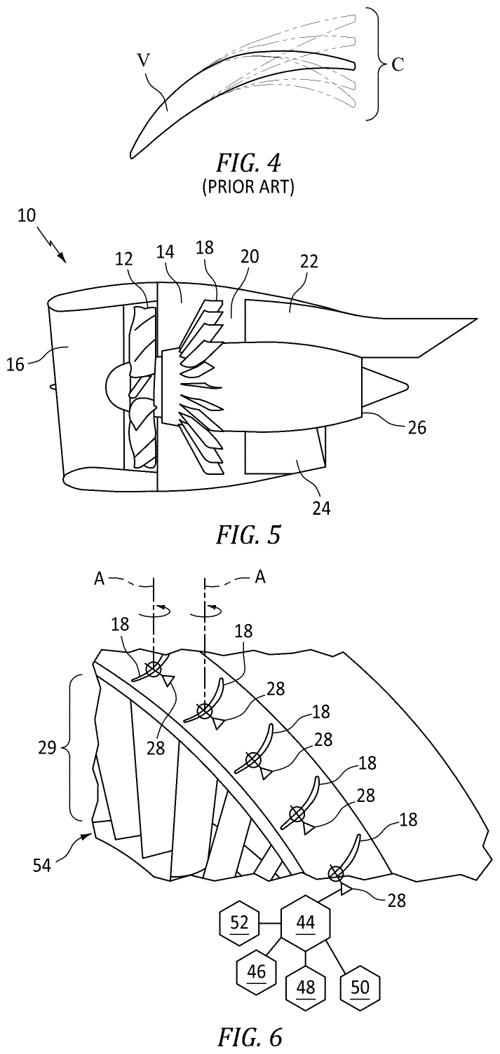

Referring now to FIG. 5, there is illustrated an exemplary gas turbine engine 10. The gas turbine engine 10 includes a fan 12 within a fan duct 14 proximate an engine inlet 16. Downstream from the fan 12 are an array of variable fan exit guide vanes 18 upstream from a bypass duct 20. An upper and lower bifurcation 22, 24 are shown downstream from the variable fan exit guide vanes 18. A core exit 26 is shown downstream from the bifurcations 22,24.

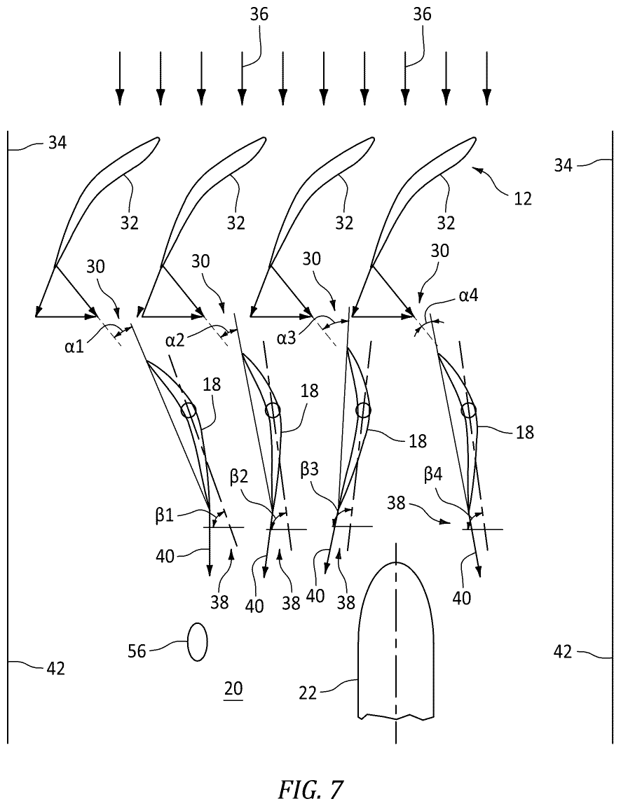

Also referring to FIG. 6 and FIG. 7, the variable fan exit guide vanes 18 can be seen. The variable fan exit guide vanes 18 are shown from a perspective view in FIG. 6 with an actuator 28 in operative communication with each variable fan exit guide vane 18. The actuator 28 can be configured to move each variable fan exit guide vane 18. In an exemplary embodiment, there can be an individual actuator 28 paired with each variable fan exit guide vane 18, there can be groups of variable fan exit guide vanes 18 paired with an actuator 28. The variable fan exit guide vane 18 can pivot around the axis A as shown in FIG. 6. The variable fan exit guide vane 18 is contiguous along the entire span 29 extending between the fan duct walls 34. Each individual variable fan exit guide vane 18 can be adjusted individually. The actuator 28 can adjust the installation angle from the original predetermined value to another installation angle value. The actuator 28 can adjust the incidence angle of the fan exit guide vane 18 during operation of the gas turbine engine 10. The adjustment of the variable fan exit guide vane 18 can result in minimizing back pressure induced fan stress during predetermined flight conditions, such as take-off, climb and cruise conditions. Unlike the traditional fixed fan exit guide vane, the variable fan exit guide vane 18 can be adjusted about the entire circumferential pattern.

As seen in FIG. 7, each individual fan exit guide vane 18 can be adjusted to a different incidence angle 30 (demarked alpha). The individual fan blades 32 are shown as part of the fan 12 in between the fan duct walls 34. Inlet air 36 is shown as flow arrows entering the fan 12. The incidence angles 30 can be varied from one variable fan exit guide vane 18 to the next.

The variable fan exit guide vane 18 can include an installation pattern angle 38 (demarked beta). The installation pattern angle 38 can also be set differently from one variable fan exit guide vane 18 to the other. As can be seen in FIG. 7, the variable fan exit guide vane exit airflow 40 is shown by arrows. The airflow 40 is shown to be adjusted based on the influence of the downstream bifurcation 22 in the bypass duct 20 bounded by the bypass duct wall 42. In an exemplary embodiment, a portion of the variable fan exit guide vanes 18 can be adjusted to direct exit airflow 40 away from a downstream object, such as the bifurcation 22. In another exemplary embodiment, a portion of the variable fan exit guide vanes 18 can be adjusted to direct exit airflow 40 toward a downstream object, such as the environmental control system inlet 56 at a predetermined gas turbine engine operating condition.

A control 44 system can be in operative communication with the actuator 28. The control system 44 may include hardware, firmware, and/or software components that are configured to perform the functions disclosed herein, including the functions of the variable fan exit guide vane 18. While not specifically shown, the control system 44 may include other computing devices (e.g., servers, mobile computing devices, etc.) and computer aided manufacturer (CAM) systems which may be in communication with each other and/or the control system 44 via a communication network 46 to perform one or more of the disclosed functions. The control system 44 may include at least one processor 48 (e.g., a controller, microprocessor, microcontroller, digital signal processor, etc.), memory 50, and an input/output: (I/O) subsystem 52. The control system 44 may be embodied as any type of computing device e.g., a server, an enterprise computer system, a network of computers, a combination of computers and other electronic devices, or other electronic devices. Although not specifically shown, the I/O subsystem 52 typically includes, for example, an I/O controller, a memory controller, and one or more I/O ports. The processor 48 and the I/O subsystem 52 are communicatively coupled to the memory 50. The memory 50 may be embodied as any type of computer memory device (e.g., volatile memory such as various forms of random access memory).

By utilizing the variable fan exit guide vane 18 and making individual adjustments, an optimal variable fan exit guide vane circumferential pattern 54 can be obtained which reduces the residual fan stress by minimizing the circumferential pressure variation sensed by the rotating fan blade 32. An optimal variable fan exit guide vane 18 circumferential pattern can also reduce fan 12 stress Harmonic response levels.

A technical advantage of the disclosed variable fan exit guide vane includes an increase in system level efficiency resulting in a decrease in thrust specific fuel consumption.

Another technical advantage of the disclosed variable fan exit guide vane includes fan efficiency increasing.

Another technical advantage of the disclosed variable fan exit guide vane includes decreasing flow loss across the variable fan exit guide vane and through the bypass duct.

Another technical advantage of the disclosed variable fan exit guide vane includes optimization of the back-pressure circumferential distribution by in-flight vanes.

There has been provided a gas turbine engine with variable fan exit guide vanes. While the gas turbine engine with variable fan exit guide vanes has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. A gas turbine engine with variable fan exit guide vanes comprising:
a fan duct supporting a circumferential pattern of variable fan exit guide vanes, the variable fan exit guide vanes being adjustable about an axis extending along a span of each of the variable fan exit guide vanes; and
an actuator in operative communication with each of the variable fan exit guide vanes, the plurality of actuators configured to independently adjust an incidence angle of each of the variable fan exit guide vanes responsive to predetermined gas turbine operating conditions; wherein each actuator is configured to adjust an installation angle from an original predetermined value to another value for each of the variable fan exit guide vanes, wherein a first incidence angle is less than a first installation angle corresponding with the first incidence angle and a second incidence angle is equal to a second installation angle corresponding with the second incidence angle and a third incidence angle is greater than a third installation angle corresponding with the third incidence angle and a fourth incidence angle is greater than a fourth installation angle corresponding with the fourth incidence angle, wherein each of the variable fan exit guide vanes can be at least one of adjusted to direct an exit airflow away from a downstream bifurcation and adjusted to direct exit airflow toward a downstream environmental control system inlet.

2. The gas turbine engine with variable fan exit guide vanes according to claim 1, wherein the first installation angle is associated with a first fan exit guide vane proximate the downstream environmental control system inlet; the third installation angle is associated with a third fan exit guide vane proximate a first side of the downstream bifurcation and the fourth installation angle is associated t guide vane proximate a second side of the downstream bifurcation wherein the first side of the downstream bifurcation is opposite the second side of the downstream bifurcation.

3. The gas turbine engine with variable fan exit guide vanes according to claim 1, wherein each of the variable fan exit guide vanes is contiguous along an entire span extending between fan duct walls supporting the variable fan exit guide vanes.

4. The gas turbine engine with variable fan exit guide vanes according to claim 1, wherein each of the individual variable fan exit guide vanes are configured individually adjustable during operation of the gas turbine engine operation.

5. The gas turbine engine with variable fan exit guide vanes according to claim 1, further comprising:
a controller in operative communication with each actuator.

6. The gas turbine engine with variable fan exit guide vanes according to claim 1, wherein each of the variable fan exit guide vanes are configured adjustable throughout the entire circumferential pattern.

7. (canceled)

8. A gas turbine engine with variable fan exit guide vanes comprising:
a fan located within a fan duct, an array of fan blades associated with the fan, each of the fan blades in the array of fan blades having a blade suction surface and a blade pressure surface opposite the blade suction surface;
a circumferential pattern of variable fan exit guide vanes supported within the fan duct downstream from the fan, each variable fan exit guide vane having a vane suction surface and a vane pressure surface opposite the vane suction surface, the variable fan exit guide vanes being adjustable about an axis extending along a span of each the variable fan exit guide vanes;
an actuator in operative communication with each of the variable fan exit guide vanes, the plurality of actuators configured to independently adjust an incidence angle of each of the variable fan exit guide vanes responsive to predetermined gas turbine operating conditions; and
a controller in operative communication with each actuator; wherein each of the variable fan exit guide vanes can be at least one of adjusted to direct an exit airflow away from a downstream bifurcation and adjusted to direct exit airflow toward a downstream environmental control system inlet; wherein the bifurcation includes a first side and a second side opposite the first side, wherein the first side of the bifurcation is exposed to the vane suction surface of a first fan exit guide vane proximate the bifurcation first side and the blade pressure surface of a first fan blade proximate the first fan exit guide vane; and wherein the second side of the bifurcation is exposed to the vane pressure surface of a second fan exit guide vane proximate the bifurcation second side and the blade suction surface of a second fan blade proximate the second fan exit guide vane.

9. The gas turbine engine with variable fan exit guide vanes according to claim 8, wherein each actuator is configured to adjust an installation angle from an original predetermined value to another value for each of the variable fan exit guide vanes such that a first installation angle associated with a first variable fan exit guide vane is less than a second installation angle associated with a second variable fan exit guide vane and the second installation angle is less than a third installation angle associated with a third variable fan exit guide vane, wherein the third variable fan exit guide vane is proximate the bifurcation and the first variable fan exit guide vane is proximate the downstream environmental control system inlet and distal from the bifurcation and the second variable fan exit guide vane is between the first variable fan exit guide vane and the second variable fan exit guide vane.

10. The gas turbine engine with variable fan exit guide vanes according to claim 8, wherein each of the variable fan exit guide vanes is contiguous along an entire span extending between fan duct walls supporting the variable fan exit guide vanes.

11. The gas turbine engine with variable fan exit guide vanes according to claim 8, wherein each of the individual variable fan exit guide vanes are configured individually adjustable during operation of the gas turbine engine operation.

12. The gas turbine engine with variable fan exit guide vanes according to claim 8, wherein each of the variable fan exit guide vanes are configured adjustable throughout the entire circumferential pattern.

13. (canceled)

14. A process for a gas turbine engine with variable fan exit guide vanes comprising:
supporting a circumferential pattern of variable fan exit guide vanes in a fan duct;
configuring the variable fan exit guide vanes adjustable about an axis extending along a span of each of the variable fan exit guide vanes; and
coupling an actuator in operative communication with each of the variable fan exit guide vanes;
configuring the plurality of actuators to independently adjust an incidence angle of each of the variable fan exit guide vanes responsive to predetermined gas turbine operating conditions;
configuring each actuator to adjust an installation angle from an original predetermined value to another value for each of the variable fan exit guide vanes, wherein a first incidence angle is less than a first installation angle corresponding with the first incidence angle and a second incidence angle is equal to a second installation angle corresponding with the second incidence angle and a third incidence angle is greater than a third installation angle corresponding with the third incidence angle and a fourth incidence angle is greater than a fourth installation angle corresponding with the fourth incidence angle; and
configuring each of the variable fan exit guide vanes can be at least one of adjusted to direct an exit airflow away from a downstream bifurcation and adjusted to direct exit airflow toward a downstream environmental control system inlet.

15. The process of claim 14, further comprising:
configuring the first installation angle associated with a first fan exit guide vane proximate the downstream environmental control system inlet; configuring the third installation angle associated with a third fan exit guide vane proximate a first side of the downstream bifurcation and configuring the fourth installation angle associated with a fourth fan exit guide vane proximate a second side of the downstream bifurcation wherein the first side of the downstream bifurcation is opposite the second side of the downstream bifurcation.

16. The process of claim 14, further comprising:
configuring each of the variable fan exit guide vanes contiguous along an entire span extending between fan duct walls supporting the variable fan exit guide vanes.

17. The process of claim 14, further comprising:
configuring each of the individual variable fan exit guide vanes individually adjustable during operation of the gas turbine engine operation.

18. The process of claim 14, further comprising:
coupling a controller in operative communication with each actuator.

19. The process of claim 14, further comprising:
configuring each of the variable fan exit guide vanes adjustable throughout the entire circumferential pattern.

20. (canceled)
